(19) United States
(12) Patent Application Publication
(10) Pub. No.: US 2025/0391942 A1
(43) Pub. Date: Dec. 25, 2025

(54) System and Method for Recycling Lithium-Ion Batteries

(71) Applicant: Ecobat Solutions, Inc., Dallas, TX (US)

(72) Inventors: Travis Wayne Hesterberg, Grapevine, TX (US); Alexander Davis Griesbach, Keller, TX (US); Colin Michael Pelletier, Euless, TX (US); Brett Harrison Horton, Southlake, TX (US)

(21) Appl. No.: 18/753,304

(22) Filed: Jun. 25, 2024

(51) Int. Cl. H01M 10/54; B09B 3/32; B09B 3/35; B09B 3/40; B09B 101/16

(52) U.S. Cl. CPC H01M 10/54; B09B 3/32; B09B 3/35; B09B 3/40; B09B 2101/16

(57) ABSTRACT

A system and method for recycling lithium-ion batteries is disclosed. The system comprises a battery input configured to receive battery material, a first shredder for processing battery material coupled to the battery input, wherein the battery material is submersed in a liquid when output from the first shredder, a drying auger coupled to the first shredder and configured to dry the battery material, and a screen coupled to the drying auger and configured to separate black mass particles from the battery material.

### TECHNICAL FIELD

The present disclosure relates, in general, to recycling systems and, more particularly, to systems and methods for recycling lithium-ion batteries.

### BACKGROUND

Lithium-ion batteries are important power sources for many consumer electronics devices and constitute a multibillion dollar market. However, the extraction of materials used to create batteries is often expensive, harmful to the environment, or both. Over time, batteries lose their ability to function sufficiently (referred to as “end-of-life” batteries). However, end-of-life batteries contain materials useful in the creation of new batteries. Black mass powder from recycled end-of-life batteries is particularly valuable. End-of-life batteries also contain copper, aluminum, plastic, and steel parts which may be recycled. Current practices for recycling end-of-life batteries are limited.

### SUMMARY OF EXAMPLE EMBODIMENTS

According to embodiments of the present disclosure, disadvantages associated with recycling end-of-life batteries may be reduced or eliminated.

In accordance with a particular embodiment of the present disclosure, a system for recycling batteries includes a battery input configured to receive battery material. The system also includes a shredder for processing battery material, coupled to the battery input. The battery material may be submersed in a liquid when output from the shredder. The system further includes a drying auger coupled to the first shredder and configured to dry the battery material, and a screen coupled to the drying auger and configured to separate black mass particles from the battery material.

In accordance with another aspect of the present disclosure, a method for recycling batteries includes receiving battery material at a battery input. The method also includes shredding the battery material using a shredder for processing battery material. The battery material may be submersed in a liquid when it is output from the shredder. The method also includes drying the battery material using a drying auger. The method also includes separating black mass particles from the battery material using a screen.

In accordance with another aspect of the present disclosure, a system for recycling batteries includes a battery input configured to receive battery material. The system also includes a first shredder for processing battery material, coupled to the battery input, and the battery material may be submersed in a liquid when output from the shredder. The system also includes a drying auger coupled to the shredder and configured to dry the battery material, and the drying auger may be a compression auger. The compression auger may configured to dry the battery material to less than 25% liquid by percent weight. The system also includes another drying auger coupled to the first drying auger and configured to use heat to dry the battery material to less than 10% liquid by percent weight. The system also includes a screen coupled to the second drying auger and configured to separate black mass particles from the battery material.

Other technical advantages of the present disclosure will be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 illustrates an example system for recycling batteries, in accordance with certain embodiments; and

FIG. 2 illustrates an example method for recycling batteries, in accordance with certain embodiments.

### DETAILED DESCRIPTION

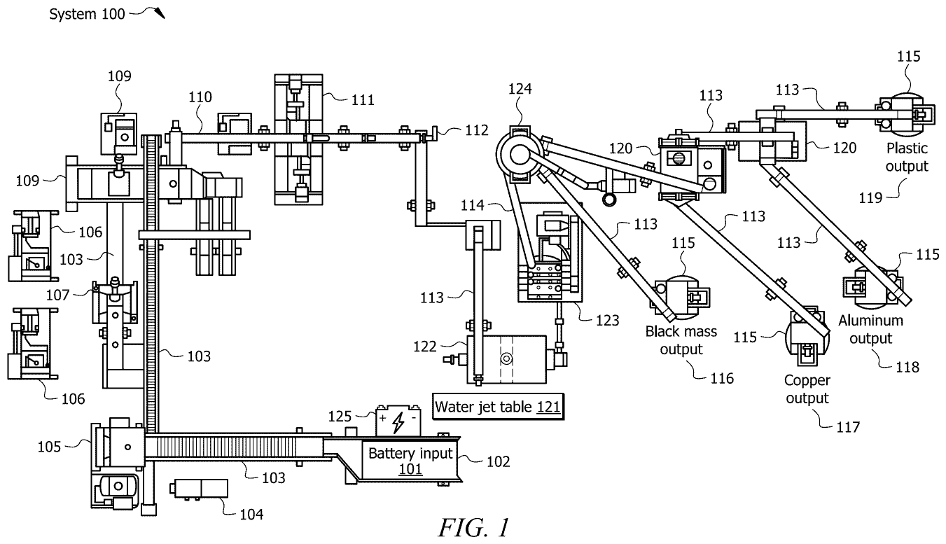

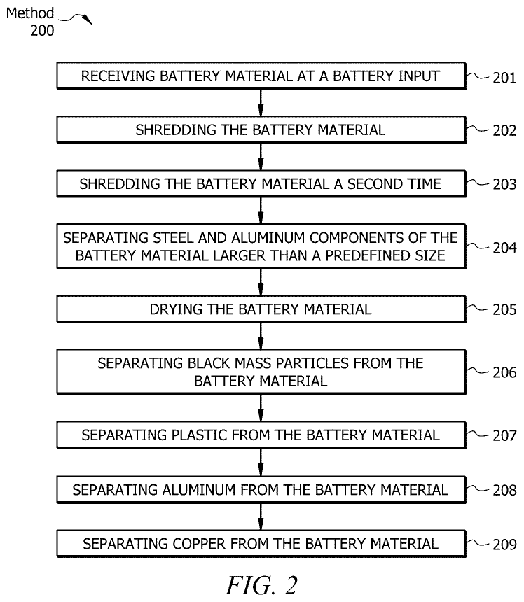

Embodiments of the present disclosure and its advantages are best understood by referring to FIGS. 1 and 2, with like numerals being used for like and corresponding parts of the various drawings.

Systems have been developed to facilitate recycling of batteries. However, existing systems suffer from significant deficiencies. For example, existing approaches for recycling batteries may cause exothermic chemical reactions, release volatile chemicals, or have other side effects that may present a safety risk for workers and may also damage expensive equipment. Another problem with existing approaches is that they are often inefficient. This can lead to yet another problem where the separation of some components of the battery material is unprofitable, resulting in some components being discarded or sold unprocessed at a lower price.

Thus, it may be desirable to have a system that eliminates or limits harmful side effects of battery recycling. It may further be desirable to have a system that efficiently separates useable recycling products such as black mass powder, copper, aluminum, plastic and steel.

FIG. 1 illustrates an example system for recycling batteries, in accordance with certain embodiments. Although FIG. 1 illustrates one example of system 100, it should be understood that this is for purposes of example only and the present disclosure is not limited to the example recycling system of FIG. 1. Rather, the present disclosure contemplates that other embodiments of system 100 may be used without departing from the scope of the present disclosure.

In the example embodiment of FIG. 1, system 100 may include components such as, for example, battery input 101, vibratory conveyor 102, hinge belt conveyor 103, control panel 104, shredder 105, hydraulic supply 106, shredder 107, density separator 108, sealed auger 109, magnetic drum separator 110, shredder 111, drying auger 112, screw conveyor 113, vibratory screen 114, loading station 116, black mass output 116, copper output 117, aluminum output 118, plastic output 119, separation tables 120, water jet table 121, dosing hopper 122, delamination mill 123, screener 124, and battery material 125. These and other components may be coupled by various means (as described in more detail below). As used throughout this disclosure, the term “couple” and/or “coupled” refers to elements which may be directly connected together or may be coupled through one or more intervening elements, whether or not those elements are in physical contact with one another.

In general, system 100 processes battery material 125 to separate recycling products such as black mass powder, copper, aluminum, plastic, and steel from battery material 125. In some embodiments, the battery material 125 may be shredded into smaller pieces using one or more shredders (e.g., shredders 105, 107, 111) to facilitate further processing of battery material 125. Battery material 125 may be submersed in a liquid to cool the battery material 125 and slow down or prevent unwanted chemical reactions caused by the shredding process. Battery material 125 may be dried to reduce its percent liquid by weight to an amount conducive for further processing. Recycling products may be separated using one or more screens and/or separation tables.

Battery input 101 may comprise any suitable receptacle, container, repository, zone, designated area, and/or combination of the same in which battery material 125 may be placed for processing by system 100. For example, battery input 101 may comprise vibratory conveyor 102. Vibratory conveyor 102 may comprise a drive unit for generating vibrational energy and a pan acting as the conveying surface of the vibrating conveyor 102. In this example embodiment, battery material 125 may be placed on vibratory conveyor 102 and may be conveyed by vibrational energy acting on the battery material 125 towards hinged belt conveyor 103. As another example, battery input 101 may be a delivery drop-off point. In some embodiments, there may be a plurality of battery inputs 101. For example, there may a different battery input 101 depending on one or more of the size, brand or product identifier, processing status, source, charge status, or capacity of the battery material 125 to be placed for processing. For example, battery material 125 that has been pre-shred may be deposited at a different battery input 101 than non-shred battery material 125. Sorting batteries into different battery inputs 101 may advantageously allow for more efficient processing of battery material 125 because some components of system 100 and/or steps of method 200 may be omitted. In embodiments with a plurality of battery inputs 101, processing of the battery material 125 in each respective battery input 101 by system 100 may occur simultaneously or in series. Battery material 125 may be placed at battery input 101 manually or by automatic process. For example, In some embodiments, human workers place battery material 125 at battery input 101. As another example, battery material 125 may be placed at battery input 101 by an automatic gantry system. As yet another example, a human worker using machine assistance may place the battery material 125 at battery input 101.

In certain embodiments, battery input 101 comprises sensors configured to weigh the battery material 125 received at battery input 101. In certain embodiments, battery input 101 may be communicatively coupled to at least one processor. In some embodiments, the processor may be in control panel 104. The processor may be configured to record the weight of battery material 125 received at battery input 101 and compare it with the weight of the battery material 125 at various points within system 100. The processor may further be configured to estimate an efficiency of system 100 based on weight measurements of battery material 125. For example, the weight of the battery material 125 at battery input 101 may be compared to the weight of black mass powder measured at black mass output 116. As another example, the weight of battery material 125 at battery input 101, measured over a set time, for example 24 hours, may be compared the to the weight of black mass powder at black mass output 116 measured over a set time, for example 24 hours, to estimate a yield rate of the system 100. In some embodiments, the efficiency of system 100 may be measured in this way for other recycling products such as steel, copper, aluminum, and/or plastic. In some embodiments, the weight of all useable recycling products may be compared to the weight of the battery material 125 at battery input 101. In some embodiments, the processor may be configured to monitor the efficiency of system 100 and alert workers if the efficiency of system 100 falls below a threshold for a set amount of time. In some embodiments, the efficiency threshold for alerting workers may be based on the current price of the recycling products processed by system 100. In some embodiments, the efficiency threshold may be 99%, 95%, 90%, 85%, 75%, or 50% efficient. In some embodiments, the set amount of time may be 1 hour, 6 hours, 12 hours, 24 hours, or 1 week. This advantageously may inform workers when recycling a certain recycling product is no longer profitable. Additionally, this may advantageously inform workers when maintenance on system 100 may be necessary.

In some embodiments, system 100 includes water jet table 121, which may comprise X-axis drive parts, Y-axis drive parts, Z-axis drive parts and cutting parts. In some embodiments, the drive parts may move and position the cutting parts which in turn may use high pressure water and an abrasive mixture to effect material removal during a cutting process. In certain embodiments, battery material 125 may be cut in smaller pieces using water jet table 121 before being placed at battery input 101. Processing battery material 125 using water jet table 121 may comprise cutting the battery material 125 into smaller pieces using water jet table 121. This may advantageously allow for system 100 to process battery material 125 larger than would otherwise be possible. For example, water jet table 121 may be used to reduce the average size of individual pieces of battery material 125 by 10%, 20%, 30%, 40%, 50%, 60%, 70%, 80%, or 90%. Processing battery material 125 using water jet table 121 before placing it at battery input 101 may also advantageously reduce the strain on and/or extend the useable life of other components of system 100, such as, for example, shredders 105, 107, and 111 (described below).

In some embodiments, system 100 includes shredders 105, 107, and/or 111 which may comprise a shredder intake, a plurality of knives, and a shredder outlet. In some embodiments, the plurality of knives may be actuated by rotating or otherwise moving the plurality of knives relative to one another such that battery material 125 may engage with the plurality of knives. In these embodiments, actuation of the plurality of knives may operate to reduce the average size of pieces of the battery material 125. In certain embodiments, the size reduction may be dependent on the thickness of the knives, the size of the battery material 125, and/or the amount of time battery material 125 remains in shredder 105. In some embodiments, shredder 105 may be coupled to battery input 101 and may receive battery material 125 at a shredder intake. In certain embodiments, the knives of shredder 105 may have a thickness of between ¼ inch and 3 inches or any suitable thickness that provides an appropriate size reduction of battery material 125. In certain embodiments, shredder 105 may operate according to predefined parameters including, but not limited to, speed of knife actuation, torque of knife actuation, and battery material pass-through rate.

In some embodiments, shredder 107 may be coupled to shredder 105. In some embodiments, shredder 107 may be coupled to shredder 105 via a hinge belt conveyor 103. The knives of shredder 107 may have a thickness of between ¼ inch and 3 inches or any suitable thickness that provides an appropriate size reduction of battery material 125. In some embodiments, the knives of shredder 107 may be less thick than the knives of shredder 105. In some embodiments, battery material 125 may pass through shredder 107 after passing through shredder 105. This may advantageously reduce the average size of individual pieces of battery material 125 to a size smaller than when they leave shredder 105. Sequencing shredders 105 and 107 in this way may advantageously reduce the strain on equipment by stepping down the average size of individual pieces of battery material 125 gradually. This may reduce the time between required maintenance and extend the life of equipment, including shredders 105 and 107. Sequencing shredders 105 and 107 in this way may further advantageously allow for a higher pass through rate of battery material 125 through system 100 and may ultimately increase the rate of output of recycling products such as steel, black mass powder, copper, aluminum, and plastic.

In some embodiments, shredder 111 may be coupled to shredder 105 and/or shredder 107. The knives of shredder 111 may have a thickness of between ¼ inch and 3 inches or any suitable thickness that provides an appropriate size reduction of battery material 125. In some embodiments, the knives of shredder 111 may be less thick than the knives of shredders 105 and 107. In some embodiments, battery material 125 may pass through shredder 111 after passing through shredders 105 and/or 107. This may advantageously reduce the average size of individual pieces of battery material 125 to a size smaller than when they leave shredder 105 and/or 107. Sequencing shredders 105, 107, and 111 in this way may advantageously reduce the strain on equipment by stepping down the average size of individual pieces of battery material 125 gradually. This may reduce the time between required maintenance and extend the life of equipment, including shredders 105, 107, and 111. Sequencing shredders 105, 107, and 111 in this way may further advantageously allow for a higher pass through rate of battery material 125 through system 100 and may ultimately increase the rate of output of recycling products such as steel, black mass powder, copper, aluminum, and plastic. In certain embodiments, shredder 111 may be coupled to magnetic drum separator 110.

In some embodiments, shredders 105, 107, and/or 111 may comprise sensors for measuring heat or discharge of chemicals including VOC gases from battery material 125. For example shredders 105, 107, and/or 111 may include a thermometer configured to measure the temperature of shredder 105. In certain, embodiments the sensors included in shredders 105, 107, and/or 111 may be coupled to a processor configured to track measurements over time. In some embodiments, shredder 105 may be configured to shut down and/or notify workers if the temperature and/or concentration of a chemical is too high. This may advantageously alert workers to an issue so that maintenance can be completed and/or workers can be evacuated from the area. In some embodiments, the system 100 may be configured to shut down or notify workers before if the temperature and/or concentration of a chemical is too high before the level at which the situation becomes dangerous.

In some embodiments, shredders 105, 107, and/or 111 may comprise an air lock capable of opening towards the intake or toward the knives of shredders 105, 107, and/or 111. In certain embodiments, once battery material 125 may be received by shredders 105, 107, and/or 111 at an intake and the air lock may be opened toward the intake for the battery material 125 to enter the airlock. In some embodiments, the air lock may be sealed once battery material 125 is inside. In certain embodiments, once the air lock is sealed, oxygen may be removed. In some embodiments, nitrogen gas may be pumped into the airlock to displace the oxygen. In some embodiments, other inert gases such as carbon dioxide are pumped into the airlock to displace the oxygen. In some embodiments, the oxygen may be pumped out of the air lock to form a vacuum. In certain embodiments, after oxygen is removed from the airlock of shredders 105, 107, and/or 111, the airlock opens towards the knives of shredders 105, 107, and/or 111.

In some embodiments, the knives of shredders 105, 107, and/or 111 may be an environment with an oxygen concentration below a threshold. In some embodiments, the threshold may be a limiting oxygen concentration for the battery material 125, or the lowest concentration of oxygen below which combustion is impossible, regardless of the concentration of fuel in the battery material 125. In some embodiments, battery material 125 may be shredded by the plurality of knives in such an environment. For example, in some embodiments, the knives of shredders 105, 107, and/or 111 may be in a sealed environment with an oxygen concentration below 5% by volume percent of oxygen. In other embodiments, the environment may have an oxygen concentration below 17%, 16%, 15%, 14%, 13%, 12%, 11%, 10%, 9%, 8%, 7%, or 6%. This may advantageously prevent combustion from occurring as a result of the engagement of battery material 125 with the plurality of knives of shredders 105, 107, and/or 111. Combustion of battery material 125 may present a safety risk to works and/or damage components of system 100. Combustion may further make recovery of recycling products more difficult and less efficient. In certain embodiments, airlocks of shredders 105, 107, and/or 111 operate to maintain the environment with an oxygen concentration below a threshold. In some embodiments, the knives of shredders 105, 107, and/or 111 may not be a sealed environment. In such embodiments, nitrogen, carbon dioxide, or other inert gases may be continually pumped over the knives during operation displacing oxygen surrounding the knives. In some embodiments, shredders 105, 107, and/or 111 have a system (e.g., a vacuum system) to remove excess inert gases to prevent a buildup of inert gases around system 100. In some embodiments, shredders 105, 107, and 111 comprise sensors for detecting the buildup of inert gases. In some embodiments, the sensors are coupled to processors configured to notify workers if the amount of inert gases as a percentage of the air becomes too high (e.g., becomes unsafe). Depending on the type of inert gas used (i.e., whether it is lighter or heavier than air), in some embodiments, the inert gas sensors of shredders 105, 107, and/or 111 may be positioned near a floor or ceiling to better measure the buildup of the inert gases.

In some embodiments, the battery material 125 may be submersed in a liquid when output from shredders 105, 107, and/or 111. In some embodiments, the battery material 125 may be misted with a liquid when output from shredders 105, 10-7, and/or 111. The liquid may be water, oil, and/or any liquid sufficient suppress chemical reactions with oxygen and/or act as a heat sink. The liquid may be provided by hydraulic supply 106. In some embodiments, the liquid may have a specific heat capacity of 5.193 J/g° C. at 25° C. and 1 bar or higher. This may advantageously reduce the temperature of battery material 125 and prevent danger to workers and/or damage to components of system 100. In some embodiments the battery material 125 may be coated in foam when output from shredders 105, 107, and/or 111. In certain embodiments, the foam may be fire retardant. In some embodiments, coating the battery material 125 in foam may have similar benefits to submersing battery material 125 in a liquid. In some embodiments, the foam may be water soluble.

In some embodiments, system 100 may include components for moving battery material 125 and/or other recycling products of system 100 between components. For example, as discussed above, shredder 105 may be coupled to battery input 101. Coupling battery input 101 to shredder 105 may comprise moving battery material 125 using an intermediate component. Examples of components for moving battery material 125 in system 100 include at least vibratory conveyor 102, hinged belt conveyor 103, sealed auger 109, drying auger 112, and screw conveyor 113. However, it should be understood that any suitable component or combination of components may be used to move battery material 125 and/or other recycling products between the various other components of system 100 may be used. For example, although not illustrated in FIG. 1, nonlimiting examples of components for moving battery material 125 and/or other recycling products include, for example, chain conveyors, roller conveyors, and/or any suitable component for moving battery material 125.

In some embodiments, components for moving battery material 125 and/or other recycling products, such as those describes above, may be configured to move the battery material 125 in a lateral (e.g. horizontal) direction, vertical direction, and/or any combination thereof. For example, In some embodiments of system 100, battery input 101 and shredder 105 may be coupled via a belt conveyor 103. The belt conveyor 103 between vibratory conveyor 102 and shredder 105 may move battery material 125 in a lateral direction from battery input 101 to shredder 105. Simultaneously, belt conveyor 103 may move battery material 125 in a vertical direction starting from the height of battery input 101 to the height of the intake of shredder 105. As another example, In some embodiments, vibratory screen 114 may be coupled to dosing hopper 122 via a screw conveyor 113. The screw conveyor 113 between vibratory screen 114 and dosing hopper 122 may also move battery material 125 both laterally and vertical direction simultaneously to facilitate moving battery material 125 to from the outlet of one component to the intake of the other.

In some embodiments, components, including components for moving battery material 125 and/or other recycling products, such as those describes above, may also be configured to be fully or partially sealed. For example, sealed auger 109 may be sealed to prevent battery material 125 leakage or contamination during transportation of the battery material 125. Sealing components for moving battery material 125 and/or other recycling products may be advantageous at to prevent or reduce oxidation or other undesirable chemical processes from occurring with respect to the battery material 125. Scaling components may also advantageously reduce the likelihood of workers being exposed to harmful materials or gases (e.g., volatile organic compound (“VOC”) gases), thereby improving the safety of system 100.

In some embodiments, system 100 includes density separator 107, which may be an air table type separator, air drum type separator, and/or separator cable of separating material based on size, shape, or density. For example, density separator 107 may be an air table type separator comprising an inclined vibrating screen deck creating a fluidized bed allowing component materials of battery material 125 to separate based on, for example, their density. Density separator 108 may be coupled to shredder 107. In some embodiments, density separator 108 may be coupled to shredder 107 via a hinge belt conveyor 103. In some embodiments, density separator 108 may be configured to receive the battery material 125 and separate steel and/or aluminum components of the battery material 125 based on at least one of the density, size, or shape of the steel and/or aluminum product to be separated. For example, in some embodiments, density separator 107 may separate steel and aluminum components of battery material 125 based on their size as compared to other components of battery material 125. As another example, density separator 107 may separate steel and aluminum components of battery material 125 because they are relatively more dense as compared to other components of battery material 125. In some embodiments, recycling products may cling to steel and aluminum components of battery material 125. In such embodiments, these steel and aluminum components may be sent for further processing. For example, steel and aluminum components to which other recycling products cling may be placed at battery input 101 for further processing by system 100.

In some embodiments, system 100 includes a magnetic drum separator 110. In certain embodiments, magnetic drum separator 110 may include a stationary, shaft-mounted magnetic circuit configured to generate a magnetic field enclosed by a rotating drum. Magnetic drum separator 110 may be coupled to density separator 108. In some embodiments, magnetic drum separator 110 may be coupled to density separator 108 via a sealed auger 109. In some embodiments, as battery material 125 reaches the rotating drum, the magnetic field attracts and holds ferrous particles to the drum shell. While the drum revolves, it may carry the material through the stationary magnetic field. Nonmagnetic material may fall freely from the shell, while the magnetic particles may remain held until they exit the magnetic field. In some embodiments, magnetic drum separator 110 may receive the battery material 125 and separate ferrous components of the battery material 125 based on at least the magnetic properties of the components to be separated.

In some embodiments, system 100 includes a drying auger 112. In some embodiments, the drying auger 112 may be a compression type auger. In certain embodiments, drying auger 112 may comprise a helical blade rotating within a cylindrical tube configured to move battery material in one direction along the center axis of the cylindrical tube. In certain embodiments, battery material 125 may be selectively allowed to leave the cylindrical tube of the drying auger 112 only when the battery material 125 is sufficiently dry. In some embodiments, drying auger 112 dries battery material 125 by compressing battery material 125 towards one end of the cylindrical tube of drying auger 112 thereby forcing liquid from between the individual pieces of battery material 125 and through a drain in the cylindrical tube of drying auger 112. In some embodiments, the drying auger 112 may use heat to reduce the percent liquid by weight of the battery material 125. In certain embodiments, the drying auger 112 may use heated inert gas to dry battery material 125. In certain embodiments, drying auger 112 may be thermally insulated. In certain embodiments, drying auger 112 may dry battery material 125 by moving heated inert gas through an insulated portion of drying auger 112. In certain embodiments, the inert gas may be, for example, carbon dioxide and/or nitrogen. Drying auger 112 may be coupled to shredder 111. A drying auger 112 may receive the battery material 125. The drying auger 112 may reduce the percent liquid by weight of the battery material 125. For example, the drying auger may reduce the liquid by percent weight of the battery material 125 to less than 30% liquid by weight. As another example, the drying auger may reduce the liquid by percent weight of the battery material 125 to less than 15%, 20%, 25%, 35%, 40% 45%, 50% and/or any other suitable percent liquid by weight. In another embodiment, drying auger 112 may be a combination of augers for reducing the percent liquid by weight of the battery material 125.

In some embodiments, system 100 includes vibratory screen 114. Vibratory screen 114 may comprise a drive unit for generating vibrational energy and a pan. Vibratory screen 114 may be coupled to drying auger 112. In some embodiments, vibratory screen 114 may apply vibrational energy to the battery material 125 on a pan. This may advantageously separate individual pieces of battery material 125 clinging to one another due to, for example, the removal of liquid from between the individual pieces of battery material 125 during a drying process. In some embodiments, vibratory screen 114 may be coupled to drying auger 112 via a screw conveyor 113. Individual pieces of battery material 125 may clump together as a result of the operation of drying auger 112. Vibratory screen may impart vibrational energy on clumped battery material 125 to break the battery material 125 into smaller pieces for easier processing by system 100.

In some embodiments, system 100 includes dosing hopper 122. In some embodiments, dosing hopper 122 may comprise any suitable receptacle, container, repository, zone, designated area, and/or combination of the same. For example, dosing hopper 122 may be a receptacle of suitable size for collecting battery material 125 before further processing. In certain embodiments, dosing hopper 122 may further comprise circuitry (e.g., processors and actuators) configured to deliver set amounts of battery material 125 to other components of system 100 per cycle of dosing hopper 122. In certain embodiments, dosing hopper 122 may be configured to deliver battery material in amounts based on weight and/or volume. For example, dosing hopper 122 may deliver 50 pounds of battery material 125 per cycle to delamination mill 123. In certain embodiments, dosing hopper 122 may be configured to deliver battery material 125 continuously at a predefined rate. For example, dosing hopper 122 may be configured to deliver battery material 125 at a rate of 50 cubic feet a minute. This may advantageously allow components such as screener 124 and separation tables 120 to avoid becoming clogged by being fed battery material 125 too quickly. It may also advantageously allow for buffer-time-allowing for maintenance of some components of system 100 without the need for shutting down all of system 100. Dosing hopper 122 may be coupled to vibratory screen 114. In some embodiments, dosing hopper 122 may be coupled to vibratory screen via a screw conveyor 113.

In some embodiments, system 100 includes delamination mill 123. In certain embodiments, delamination mill 123 may comprise breakers and grinders driven by one or more motors. In some embodiments, breakers and grinders of delamination mill 123 may engage battery material 125 and reduce the average size of individual pieces of battery material 125. In certain embodiments, operation of delamination mill 123 may cause individual pieces of battery material 125 to have a uniform shape. In some embodiments, operation of delamination mill 123 may cause battery material 123 to have a uniform, round shape. This may advantageously increase the accuracy of subsequent separation using, for example, screener 124 or separation tables 120. For example, battery material 125 may enter delamination mill 125 with roughly filament shaped individual pieces and may leave delamination mill 123 as rounded balls of uniform size. Delamination mill 123 may be coupled to dosing hopper 122. In some embodiments, delamination mill 123 physically breaks battery material 125 into individual pieces by breaking apart positively connected parts and delaminating battery material 125 pieces at phase boundaries.

In some embodiments, system 100 includes one or more separation tables 120. In some embodiments, separations tables 120 are air type separation tables. For example, in some embodiments, separation tables may comprise a flat surface configured to provide eccentric motion (e.g., a combination of shaking and tilting) to battery material 125. In these embodiments, battery material passes across a fluidized bed of air which, when combined with the eccentric motion, causes heavier particles to settle more quickly than lighter particles (which are carried away by the air). This may advantageously allow for separation of particles based on their relative density. In some embodiments, each separation table may be configured to separate a specific recycling product of system 100 such as copper, aluminum, or plastic. Separation tables 120 may be coupled to screener 124. In some embodiments, separation tables 120 may be coupled to screener 120 via screw conveyors 113. In some embodiments, one or more separation tables 120 may further process battery material 125 once black mass powder is extracted. In some embodiments, system 100 includes screener 124. In various embodiments, screener 124 may be a vibrating type screen, a disc type screen, or a trommel type screen, and/or any component capable of separating black mass powder from other components of battery material 125. In some embodiments, screener 124 may have the same or similar operation as separation tables 120. In some embodiments, screener 124 may be configured to separate black mass powder from battery material 125 using one or more screens. Screener 124 may be coupled to delamination mill 123. In some embodiments, screener 124 may be coupled to delamination mill 123 via a screw conveyor 113.

In some embodiments, system 100 includes black mass output 116. Black mass output 116 may be coupled to screener 124. In some embodiments, black mass output 116 may be coupled to screener 120 via screw conveyor 113. In some embodiments, separated black mass powder may be collected at black mass output 116. Black mass output 116 may comprise any suitable receptacle, container, repository, zone, designated area, and/or combination of the same. In some embodiments, as shown in FIG. 1, black mass output 116 may be a loading station 115.

In some embodiments, system 100 includes copper output 117. Copper output 117 may be coupled to a separation table 120. In some embodiments, copper output 117 may be coupled to separation tables 120 via screw conveyors 113. In some embodiments, separated copper material may be collected at copper output 117. Copper output 117 may comprise any suitable receptacle, container, repository, zone, designated area, and/or combination of the same. In some embodiments, as shown in FIG. 1, copper output 117 may be a loading station 115.

In some embodiments, system 100 includes aluminum output 118. Aluminum output 118 may be coupled to a separation table 120. In some embodiments, aluminum output 118 may be coupled to separation table 120 by a screw conveyor 113. In some embodiments, separated aluminum material may be collected at aluminum output 118. Aluminum output 118 may comprise any suitable receptacle, container, repository, zone, designated area, and/or combination of the same. In some embodiments, as shown in FIG. 1, aluminum output 118 may be a loading station 115.

In some embodiments, system 100 includes plastic output 119. Plastic output 119 may be coupled to a separation table 120. In some embodiments, plastic output 119 may be coupled to separation table 120 by a screw conveyor 113. In some embodiments, separated plastic material may be collected at plastic output 119. Plastic output 119 may comprise any suitable receptacle, container, repository, zone, designated area, and/or combination of the same. In some embodiments, as shown in FIG. 1, plastic output 119 may be a loading station 115.

Although FIG. 1 illustrates a particular arrangement of elements of system 100, it should be understood that the present disclosure is not limited to the precise arrangement of the example embodiment of FIG. 1. Modifications, additions, or omissions may be made to system 100 described herein without departing from the scope of the disclosure. For example, system 100 may include any number of shredders 105, separation tables 120, or hinge belt conveyors 103. As another example, particular functions, such as shredding battery material 125 may be performed by a separate component and system 100 may receive pre-shred battery material 125. As yet another example, system 100 may omit some or all of separation tables 120 based on the recycling products to be derived from battery material 125. The components may be integrated or separated. Moreover, the operations may be performed by more, fewer, or other components. Additionally, some functions, including control functions, may be performed using any suitable logic comprising software, hardware, and/or other logic.

FIG. 2 is an example method for recycling batteries, in accordance with certain embodiments. In some embodiments, method 200 may be performed by one or more components of system 100 of FIG. 1.

At step 201, battery material 125 may be received at a battery input 101. In some embodiments, battery material 125 may be processed prior to being received at battery input 101. For example, battery material 125 may arrive at battery input 101 already shredded. As another example, battery material 125 may arrive at battery input 101 with all plastic casing removed. In some embodiments, battery material 125 arrives at battery input at some level of charge. For example, battery material 125 may arrive at battery input 101 with at least 95%, 90%, 85%, 80%, 75%, 70%, 65%, 60%, 55%, 50%, 45%, 40%, 35%, 30%, 25%, 20%, 15%, 10%, or 5% charged. In some embodiments, battery material 125 may arrive at battery input 101 with substantially no charge. In some embodiments, step 201 may further comprise draining battery material 125 of any remaining charge. Draining the battery material 125 before further processing may advantageously make battery material 125 less volatile during processing by, for example, system 100.

At step 202, battery material 125 may be shred. In some embodiments, battery material 125 may be shred using shredder 105. At step 203, battery material 125 may be shred a second time. In some embodiments, the battery material 125 may be shredded a second time by shredder 107. In some embodiments, steps 202 and/or may be omitted. For example, if battery material 125 may be received at battery input 101 pre-shred, steps 202 and/or 203 may be omitted. In some embodiments, battery material may be treated with fire-retardant chemicals before being shred in steps 202 or 203. This may advantageously prevent battery material 125 from catching fire during the shredding process. In some embodiments, steps 202 and/or 203 may be performed while battery material 125 may be submersed in a liquid. This may advantageously absorb heat from battery material 125 and prevent chemicals in battery material 125 from reacting with air during the shredding process.

At step 204, steel and aluminum components of battery material 125 larger than a predefined size may be separated. In some embodiments, density separator 108 may receive the battery material 125 and separate steel and/or aluminum components of the battery material 125 based on at least one of the density, size, or shape of the steel and/or aluminum product to be separated. In some embodiments, step 204 may be omitted. For example, if battery material 125 arrives at battery input 125 without steel or aluminum components, step 204 may be omitted. In some embodiments, only one of steel or aluminum may be separated from battery material 125.

At step 205, the battery material 125 may be dried. In some embodiments, drying auger 112 may perform this step. In other embodiments, this step may be performed by another component. For example, this step may be performed by a mechanical type dryer, hot air type dryer, loop type dryer, vent hood with air circulation, hot air blower, or any other component suitable for drying battery material 125. In some embodiments, battery material 125 may be dried to 50%, 45%, 40%, 35%, 30%, 25%, 20% 15%, 10%, 5%, or 1% liquid by weight. In some embodiments, step 205 may be performed by components in a series. For example, a first component may dry battery material 125 to a first percentage of liquid by weight and a second component may further dry battery material 125 to a differ percentage liquid by weight. In some embodiments, different battery material 125 may be dried to different percentages of liquid by weight depending on the composition of battery material 125. For example, battery material 125 containing less plastic material may be dried to a comparatively higher percent liquid by weight than battery material 125 containing more plastic material. Tailoring the percent liquid by weight that battery material 125 may be dried to may advantageously allow for more efficient separation of recycling products from battery material 125.

At step 206, black mass particles may be separated from battery material 125. In some embodiments, screener 124 may separate black mass powder from battery material 125 using one or more screens. In certain embodiments, battery material 125 may be processed such that it comprises individual pieces of uniform size and shape. In these embodiments, screener 120 may separate black mass powder from other recycling products of battery material 125 based on the relatively higher density of black mass powder as compared to the other potential recycling products in battery material 125. In some embodiments, black mass powder may be deposited at black mass out 116.

At step 207, plastic may be separated from battery material 125. In some embodiments, a separation table 120 separates plastic material from the battery material 125. In some embodiments, separation table 120 may separate plastic material from battery material 125 using one or more screens. In certain embodiments, battery material 125 may be processed such that it comprises individual pieces of uniform size and shape. In these embodiments, separation table 120 may separate plastic material from other recycling products of battery material 125 based on the relatively higher density of plastic as compared to the other potential recycling products in battery material 125. In some embodiments, plastic may be deposited at plastic output 119. In some embodiments, other recycling products are removed from battery material 125 before step 207.

At step 208, aluminum may be separated from battery material 125. In some embodiments, a separation table separates aluminum material from the battery material 125. In some embodiments, separation table 120 may separate aluminum material from battery material 125 using one or more screens. In certain embodiments, battery material 125 may be processed such that it comprises individual pieces of uniform size and shape. In these embodiments, separation table 120 may separate aluminum material from other recycling products of battery material 125 based on the relatively higher density of aluminum as compared to the other potential recycling products in battery material 125. In some embodiments, aluminum material may be deposited at aluminum output 118. In some embodiments, other recycling products are removed from battery material 125 before step 208.

At step 209, copper may be separated from battery material 125. In some embodiments, a separation table separates copper material from the battery material 125. In some embodiments, separation table 120 may separate copper material from battery material 125 using one or more screens. In certain embodiments, battery material 125 may be processed such that it comprises individual pieces of uniform size and shape. In these embodiments, separation table 120 may separate copper material from other recycling products of battery material 125 based on the relatively higher density of aluminum as compared to the other potential recycling products in battery material 125. In some embodiments, aluminum material may be deposited at copper output 117. In some embodiments, other recycling products are removed from battery material 125 before step 209.

Modifications, additions, or omissions may be made to the methods described herein without departing from the scope of the disclosure. For example, the steps may be combined, modified, or deleted where appropriate, and additional steps may be added. For example, steps 207-209 may be omitted; rather than separating out recycling products such as plastic, aluminum, and copper, these recycling products may be left as a part of battery material 125 which may be sold for further processing. Additionally, the steps may be performed in any suitable order without departing from the scope of the present disclosure.

Modifications, additions, or omissions may be made to the systems and apparatuses described herein without departing from the scope of the disclosure. The components of the systems and apparatuses may be integrated or separated. Moreover, the operations of the systems and apparatuses may be performed by more, fewer, or other components.

Additionally, operations of the systems and apparatuses may be performed using any suitable logic comprising software, hardware, and/or other logic.

Modifications, additions, or omissions may be made to the methods described herein without departing from the scope of the disclosure. The methods may include more, fewer, or other steps. Additionally, steps may be performed in any suitable order.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the spirit and scope of this disclosure, as defined by the following claims.

What is claimed is:

1. A system for recycling batteries, the system comprising:
a battery input configured to receive battery material;
a first shredder for processing battery material, coupled to the battery input, wherein the battery material is submersed in a liquid when output from the first shredder;
a drying auger coupled to the first shredder and configured to dry the battery material; and
a screen coupled to the drying auger and configured to separate black mass particles from the battery material.

2. The system of claim 1, wherein the first shredder comprises an environment with an oxygen concentration below a threshold, the threshold being a limiting oxygen concentration for the battery material.

3. The system of claim 1, further comprising a second shredder for processing battery material, wherein the first shredder for processing battery material further comprises a first plurality of knives, wherein the second shredder for processing battery material comprises a second plurality of knives, and wherein a thickness of the first plurality of knives is less than a thickness of the second plurality of knives.

4. The system of claim 1, further comprising:
a second screen configured to separate plastic from the battery material;
a third screen configured to separate aluminum from the battery material; and
a fourth screen configured to separate copper from the battery material.

5. The system of claim 1, wherein the drying auger is configured to dry the battery material to less than 30% liquid by percent weight.

6. The system of claim 1, wherein the drying auger is a compression auger and wherein the compression auger is configured to dry the battery material to less than 30% liquid by percent weight.

7. The system of claim 1, wherein the drying auger is configured to use heat to dry the battery material to less than 15% liquid by percent weight.

8. The system of claim 1, further comprising a density separator configured to separate steel and aluminum components of the battery material larger than a predefined size.

9. The system of claim 1, wherein the liquid is water.

10. The system of claim 1, further comprising a water-jet table configured to cut the battery material to a predefined size.

11. A method for recycling batteries, the method comprising:
receiving battery material at a battery input;
shredding the battery material using a first shredder for processing battery material, wherein the battery material is submersed in a liquid when output from the first shredder;
drying the battery material using a drying auger; and
separating black mass particles from the battery material using a screen.

12. The method of claim 11, wherein the first shredder comprises an environment with an oxygen concentration below a threshold, the threshold being a limiting oxygen concentration for the battery material.

13. The method of claim 11, further comprising shredding the battery material a second time using a second shredder for processing battery material, wherein the first shredder for processing battery material further comprises a first plurality of knives, wherein the second shredder for processing battery material comprises a second plurality of knives, and wherein a thickness of the first plurality of knives is less than a thickness of the second plurality of knives.

14. The method of claim 11, further comprising:
separating plastic from the battery material using a second screen;
separating aluminum from the battery material using a third screen; and
separating copper from the battery material using a fourth screen.

15. The method of claim 11, wherein the drying auger is configured to dry the battery material to less than 30% liquid by percent weight.

16. The method of claim 11, wherein the drying auger is a compression auger and wherein the compression auger is configured to dry the battery material to less than 30% liquid by percent weight.

17. The method of claim 11, wherein the drying auger uses heat to dry the battery material to less than 15% liquid by percent weight.

18. The method of claim 11, further comprising separating steel and aluminum components of the battery material larger than predefined size using a density separator.

19. The method of claim 11, further comprising cutting the battery material to a predefined size using a water-jet table.

20. A system for recycling batteries, the system comprising:
a battery input configured to receive battery material;
a first shredder for processing battery material, coupled to the battery input, wherein the battery material is submersed in a liquid when output from the first shredder;
a first drying auger coupled to the first shredder and configured to dry the battery material, wherein the first drying auger is a compression auger and wherein the compression auger is configured to dry the battery material to less than 25% liquid by percent weight;
a second drying auger coupled to the first drying auger and configured to use heat to dry the battery material to less than 10% liquid by percent weight; and
a screen coupled to the second drying auger and configured to separate black mass particles from the battery material.
